(19) United States
(12) Patent Application Publication
(10) Pub. No.: US 2005/0194826 A1
(43) Pub. Date: Sep. 8, 2005

(54) Seat latch and latching method

(76) Inventors: Timothy S. O'Callaghan, Fenton, MI (US); James Nelsen, Howell, MI (US)

Correspondence Address: MICHAEL BEST & FRIEDRICH, LLP, 100 E WISCONSIN AVENUE, MILWAUKEE, WI, 53202, US

(21) Appl. No.: 10/791,306

(22) Filed: Mar. 2, 2004

(51) Int. Cl. B60N 2/02

(52) U.S. Cl. 297/378.13

(57) ABSTRACT

A seat latch for controlling operation of a vehicle seat within a vehicle. In some embodiments, the seat latch includes a housing connectable to either of the vehicle seat or the vehicle and a user-manipulatable control supported by the housing. The user-manipulatable control can be operable to facilitate movement of the seat latch between a latched condition in which the vehicle seat is secured against movement with respect to the vehicle, and an unlatched condition in which the vehicle seat can be moved with respect to the vehicle. The user-manipulatable control can also be actuated to facilitate movement of the seat back between a plurality of reclined orientations, and can provide a visual indicator that the seat latch is not in the latched condition.

### BACKGROUND OF THE INVENTION

Many conventional vehicles generally have two varieties of configurations in which different types of vehicle seats are frequently employed. The vehicles typically have either a two-door configuration or a four-door configuration. In vehicles having two-door configurations, vehicle seats having folding seat backs that fold toward a seat base and/or vehicle seats that move to a dump position (in which a seat base of the seat moves toward the front of the vehicle and a seat back of the seat folds toward the seat base) are commonly employed to facilitate easier access to a back seat of the vehicle or to the space behind the seats. Four-door configurations typically have doors that facilitate access to the back seat of the vehicle, thereby often eliminating the need for seats to move to dump positions. However, in both two and four-door configurations, it is often desirable to obtain access behind the rearmost seats of the vehicle, such as to obtain access to a storage area behind such seats.

Seats operable to fold or move to dump positions typically have at least one lever extending from the seat and manipulatable by an operator. In such cases, the lever is connected to a seat latch having a latched condition in which the seat is secured in a position that is safe for the operator to occupy the seat, and an unlatched condition in which the seat is foldable or movable to a dump position. Commonly, the lever is generally rotatable about a pivot to move the seat latch between the latched and unlatched conditions.

Such a lever commonly has a position corresponding to the latched condition of the seat latch and another position corresponding to the unlatched condition of the seat latch. However, it is typically difficult or impossible for an operator to visibly determine which position the lever is in and to which condition the lever position corresponds. Operator confusion regarding the condition of the seat latch is clearly an undesirable feature of such latches.

Also, these and other levers typically project out from vehicle seats, and can be snagged by a seat belt, loose clothing, a purse, and the like, and can be accidentally bumped by an operator. Such snagging or bumping can damage items and the lever, and can accidentally cause the lever to move between positions—both undesirable results of the lever's design.

Conventional seat controls often employ multiple levers or other user-actuatable elements to perform various seat moving and seat adjustment functions (such as moving the seat to and/or from a dump position as described above, reclining the seat to different desired positions, and the like). The use of multiple levers or other user-actuatable controls can increase the difficulty of learning and using the controls of the seat and can increase the cost of the seat and its controls.

In light of the problems and limitations described above and in light of still other problems and limitations of conventional seat latches, new seat latches and seat latching and adjusting methods would be welcome in the art.

### SUMMARY OF THE INVENTION

Some embodiments of the present invention provide for a seat latch for controlling operation of a vehicle seat within a vehicle, the vehicle seat having a seat base and a selectively positionable seat back pivotally coupled to the seat base, wherein the seat latch comprises a frame connectable to one of the vehicle seat and the vehicle, and a user-manipulatable control supported by the frame, the user-manipulatable control operable to facilitate movement of the seat latch between a latched condition in which at least part of the vehicle seat is secured against movement with respect to the vehicle and an unlatched condition in which the at least part of the vehicle seat is movable with respect to the vehicle, wherein the user-manipulatable control is also operable to facilitate movement of the seat back between a plurality of reclined positions; and wherein the user-manipulatable control is retained in at least one position when the seat is in the unlatched condition and in which the user-manipulatable control provides a visual indication that the seat latch is not in the latched condition.

In another aspect of the present invention, a seat latch having a reclining condition, a latched condition and an unlatched condition is provided, and comprises a housing, a user-manipulatable control received at least partially within the housing, movable along a first path to move the seat latch from the latched condition to the unlatched condition, and movable along a second path to move the seat latch into and out of the reclining condition but retaining the seat latch in the latched condition, wherein the user-manipulatable control protrudes outside of the housing when the latch is in the unlatched condition and does not protrude beyond the housing when the latch is in the latched condition.

Also, in some embodiments of the present invention, a seat latch for a vehicle seat within a vehicle is provided, and comprises a frame connectable to one of the vehicle seat and the vehicle, a striker connectable to the other of the vehicle seat and the vehicle, a ratchet coupled to the frame and selectively engagable with the striker to selectively secure the frame to the striker, a user-manipulatable control coupled to the ratchet and movable from a first position to a second position to facilitate reclining of the vehicle seat, and from the first position to a third position to facilitate disengagement of the frame from the striker, and a biasing member coupled to the user-manipulatable control and biasing the user-manipulatable control toward the first position when the user-manipulatable control is in the second position, wherein the biasing member does not bias the user-manipulatable control toward the first position when the user-manipulatable control is in the third position.

In yet another aspect of the present invention, a method of moving a seat within a vehicle is provided, and comprises actuating a user-manipulatable control in a first manner to release a latch from a striker and to enable movement of the vehicle seat with respect to the vehicle, wherein the latch provides a visual indicator to a user that the latch is in an unlatched condition when the latch is released from the striker, capturing the striker with the latch, and actuating the user-manipulatable control in a second manner different from the first manner to recline the seat.

More information and a better understanding of the present invention can be achieved by reference to the following drawings and detailed description.

### BRIEF DESCRIPTION OF THE DRAWINGS

The present invention is further described with reference to the accompanying drawings, which illustrate an embodiment of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

Terms of orientation (e.g., front, rear, top, bottom, side, vertical, horizontal, and the like) are employed herein for simplifying the description of the various embodiments of the present invention. However, such terms are used with reference only to exemplary embodiments of the present invention, and do not indicate or imply that the element or structure referred to must be oriented in the described manner. The latch assembly and elements of the present invention can be oriented in any manner desired while still performing the latch functions described herein and while still falling within the spirit and scope of the present invention.

In the drawings, wherein like reference numerals indicate like parts:

FIG. 1 is a front perspective view of a seat latch according to an exemplary embodiment of the present invention, shown with the seat latch in a latched condition and with a housing of the seat latch in phantom;

FIG. 2 is another front perspective view of the seat latch of FIG. 1, shown with the seat latch in an unlatched condition;

FIG. 3 is another front perspective view of a latch assembly of the seat latch of FIGS. 1 and 2, shown with the seat latch in an unlatched condition and with a housing of the seat latch in phantom;

FIG. 4 is a rear perspective view of the latch assembly of FIGS. 1-3, shown with the seat latch in an unlatched condition and with the housing of the seat latch removed;

FIG. 5 is a rear perspective view of a striker assembly of the seat latch of FIGS. 1-4;

FIG. 6 is a top view of the striker assembly of FIG. 5;

FIG. 7 is a perspective view of a vehicle seat with the latch assembly of FIGS. 1-6 connected thereto and the striker assembly of FIGS. 5 and 6 connected to a vehicle;

FIG. 8 is a top view of the vehicle seat and latch assembly of FIG. 8, shown without the latch housing;

FIG. 9 is an enlarged rear view of the seat latch of FIGS. 1-4, shown in a latched condition and without the latch housing;

FIG. 10 is a enlarged rear view of the seat latch of FIGS. 1-4, shown in a reclined condition and without the latch housing;

FIG. 11 is a front perspective view of the seat latch of FIGS. 1-4, shown in a first unlatching position and without the latch housing;

FIG. 12 is a front perspective view of the seat latch of FIGS. 1-4, shown in a second unlatching position corresponding to the unlatched condition of the seat latch and without the latch housing; and

FIG. 13 is a rear perspective view of the seat latch of FIG. 12, shown without the striker assembly and the latch housing.

### DETAILED DESCRIPTION OF THE DRAWINGS

The present invention is described in terms of its application to a seat latch for a vehicle seat. However, the present invention is not limited in its application to any particular type of vehicle seat other than vehicle seats adapted to recline and/or move to a dump position. In addition, the seat latch 20 can be employed for a seat in any location in a vehicle (e.g., front or rear seat, center or side seat, and the like). The seat latch illustrated in the figures is presented herein by way of example only.

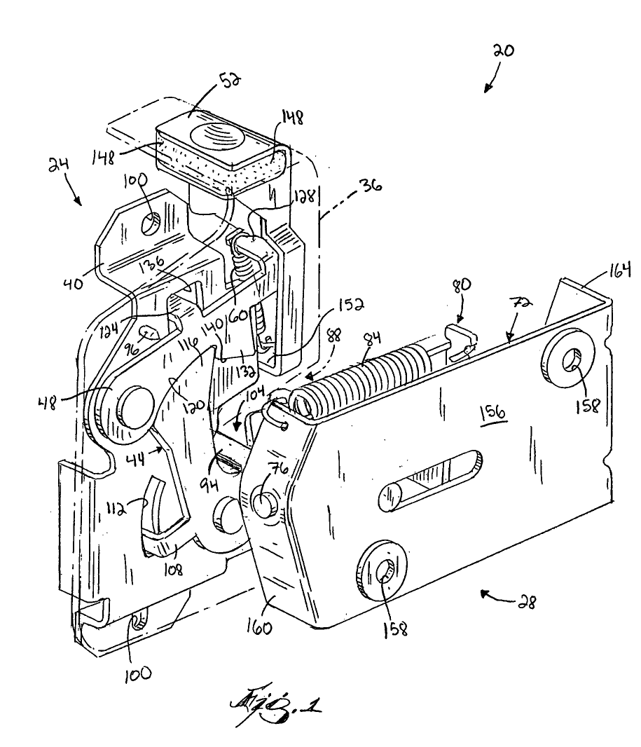

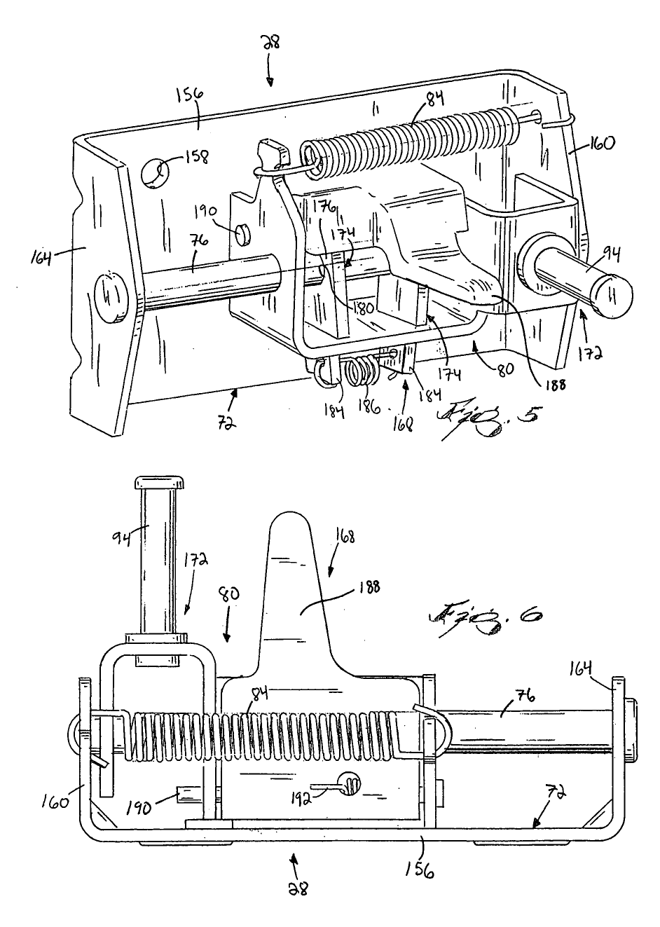

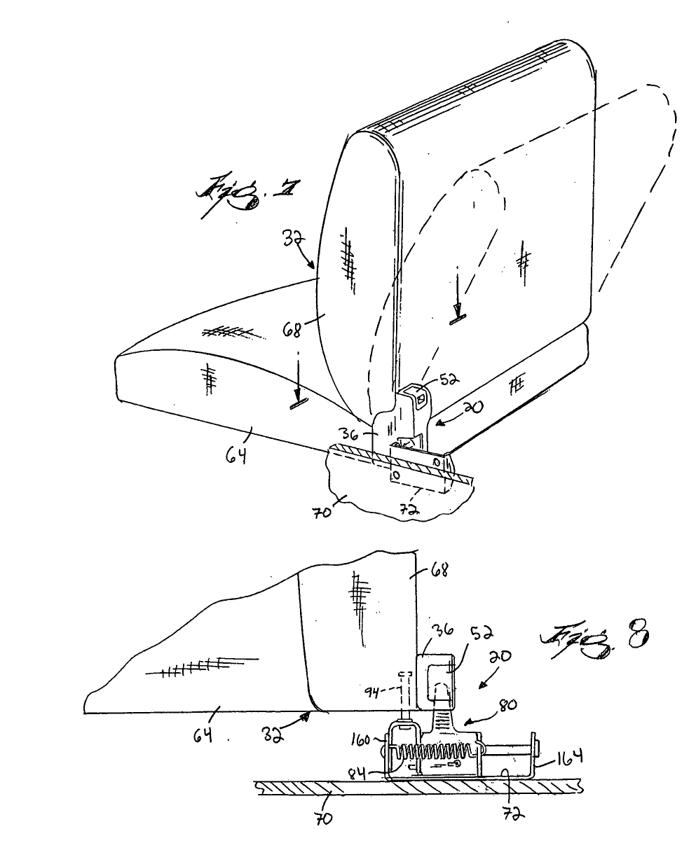

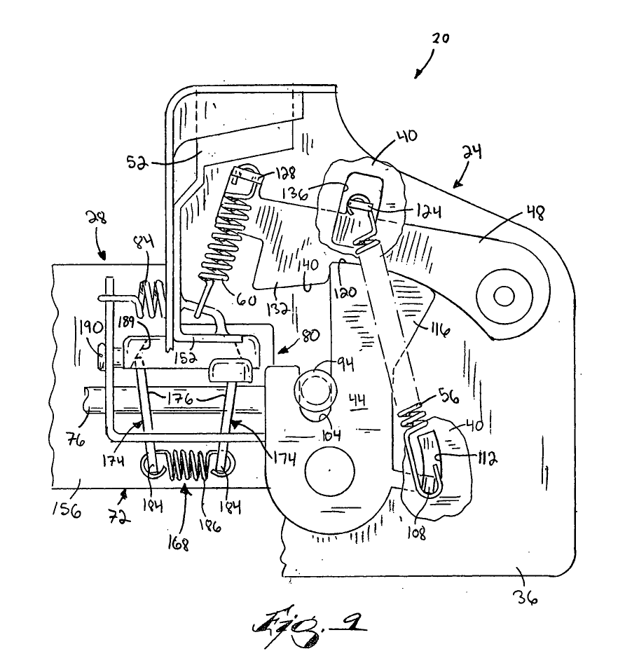

FIG. 1 illustrates a seat latch 20 according to an exemplary embodiment of the present invention. The seat latch 20 in the figures includes a latch assembly 24 and a striker assembly 28. The latch assembly 24 is connectable to a vehicle seat 32 (see FIGS. 7 and 8), and can include a latch assembly housing 36, a support bracket 40, a ratchet 44, a pawl 48, a user-manipulatable control 52, and first and second biasing members 56, 60. The vehicle seat 32 has a seat base 64 and a seat back 68 (see FIGS. 7 and 8) pivotally connected to the seat base 64 and movable between a substantially vertical position and at least one position reclined with respect to the substantially vertical position. The striker assembly 28 is inter-connectable with the latch assembly 24, and is connectable to a vehicle 70 (see FIGS. 7 and 8). In some embodiments, the striker assembly 28 includes a striker assembly housing 72 and a carriage slide 76, carriage 80, and carriage biasing member 84 (see FIGS. 5 and 6).

In the state shown in FIG. 1, the seat latch 20 is in a latched condition in which the seat back 68 is not movable relative to the vehicle and is not rotatable with respect to the seat base 64. In those embodiments in which the seat is movable to a “dump” position (i.e., the seat 32 is movable forwardly to permit access behind the seat 32), the seat latch 20 restrains such movement in the latched condition of FIG. 1.

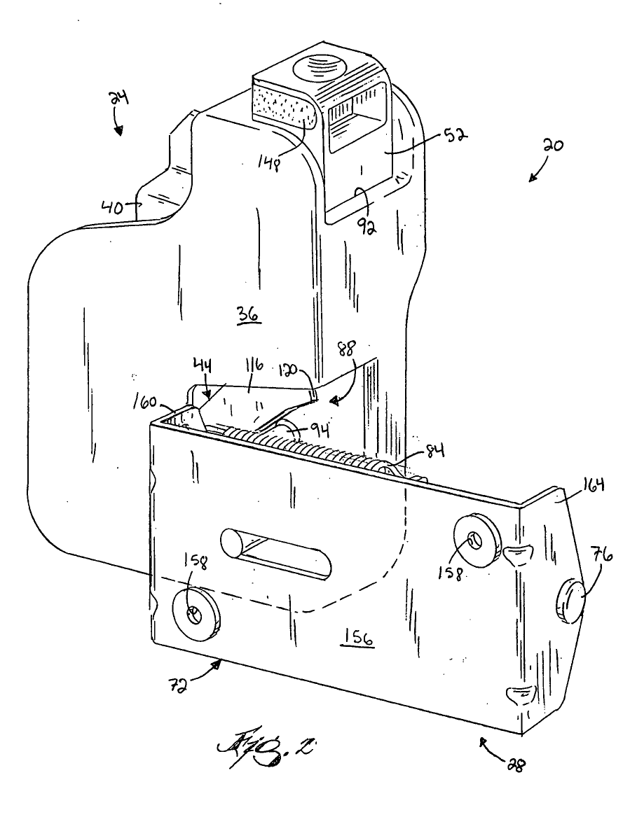

Referring to FIG. 2, the seat latch 20 is illustrated in an unlatched condition in which the latch assembly 24 and the striker assembly 28 are not secured with respect to one another. In this unlatched condition, the seat 32 is movable relative to the vehicle 70 (i.e., carrying with it the latch assembly 24 mounted thereto) and the seat back 68 is foldable toward the seat base 64. In those embodiments in which the seat 32 is movable to a “dump” position, the seat latch 20 permits such movement in the unlatched condition of FIG. 2. Movement of the seat latch 20 between the latched and unlatched conditions will be discussed in greater detail below.

In the illustrated embodiment, the latch assembly 24 and the striker assembly 28 are configured to connect to the seat 32 and the vehicle 70, respectively. Alternatively, the latch assembly 24 could be connected to the vehicle 70 and the striker assembly 28 could be connected to the seat 32 to provide similar latch and seat operation while still falling within the spirit and scope of the present invention.

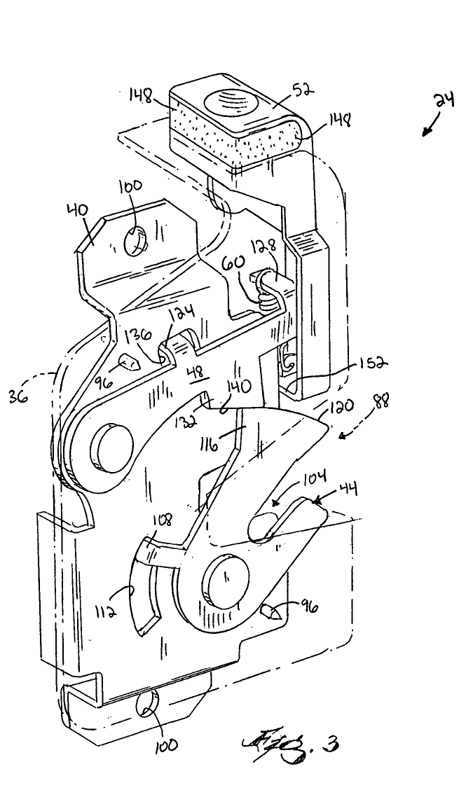

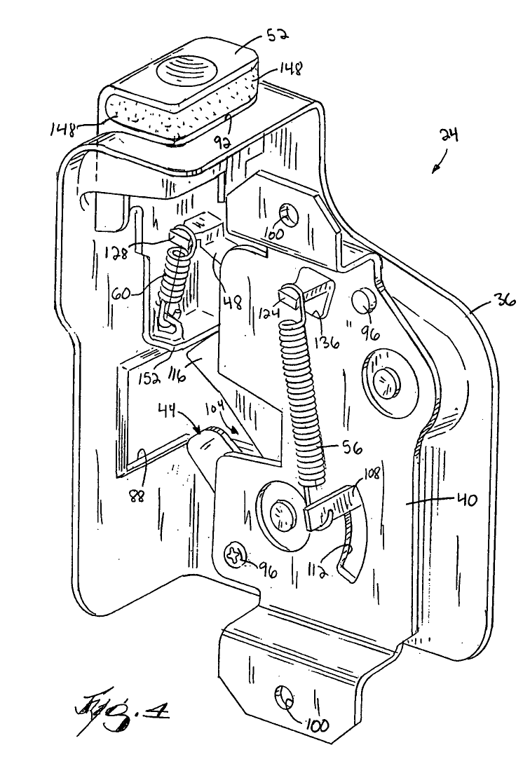

Referring to FIGS. 3 and 4, the latch assembly 24 of FIGS. 1 and 2 is illustrated in the unlatched condition. In this embodiment, the latch assembly housing 36 defines a latch aperture 88 and an aperture 92. The latch aperture 88 is operable to receive a striker 94 (discussed below) of the striker assembly 28 therein, while the user-manipulatable control 52 is supported within the aperture 92 and is movable therein with respect to the latch assembly housing 36.

The latch assembly housing 36 can have any shape desired in order to at least partially enclose any portion or all of the latch assembly 24. In some alternative embodiments, the latch assembly 24 has no latch assembly housing 36 as just described.

The support bracket 40 is connected to the housing 36 in any conventional manner, such as by fasteners 96 as shown, by welding, brazing, riveting, or in any other suitable manner. In some embodiments, the support bracket 40 includes one or more seat connecting apertures 100 defined therethrough for receiving fasteners (not shown) to mount the latch assembly 24 to the vehicle seat 32 or the vehicle 70. However, in other embodiments, the latch housing 36 is provided with such apertures for this purpose. In still other embodiments, the latch assembly 24 can be mounted to a structure (e.g., a vehicle seat 32 or vehicle frame 70 or other vehicle portion) in any other manner, such as by welding, brazing, riveting, clamping, inter-engaging elements on the latch assembly 24 and vehicle structure, adhesive or cohesive bonding material, and the like.

The ratchet 44 is pivotally connected to the support bracket 40, and defines a latch slot 104 for receiving the striker 94 therein (discussed in greater detail below). In some embodiments, the ratchet 44 includes a ratchet biasing arm 108 that extends through a ratchet slot 112 defined through the support bracket 40, and extends substantially perpendicular to the support bracket 40. In other embodiments, the ratchet biasing arm 108 can extend in other directions through the support bracket 40 while still permitting movement of the ratchet 44 with respect to the support bracket 40. The ratchet 44 can also include a ratchet cam arm 116 having a ratchet cam surface 120 engagable with the pawl 48.

The pawl 48 in the illustrated exemplary embodiment is also pivotally connected to the support bracket 40, and includes first and second pawl biasing arms 124, 128 and a pawl cam arm 132. The first pawl biasing arm 124 extends through a pawl slot 136 defined through the support bracket 40 and extends substantially perpendicular to the support bracket 40. The second pawl biasing arm 128 extends generally in the same direction as the first pawl biasing arm 124. In other embodiments, the pawl biasing arms 124, 128 can extend from the pawl 48 in other directions while still performing the spring attachment functions described in greater detail below. The pawl cam arm 132 extends toward the ratchet 44 and includes a pawl cam surface 140 engagable with the ratchet cam surface 120.

The support bracket 40 in the illustrated exemplary embodiment provides mounting locations by which the latch assembly 24 can be mounted to the vehicle seat 32 (or to the vehicle frame 70 or other structure in alternate arrangements as described herein) and provides a supporting structure to which elements of the latch assembly 24 are mounted. However, it will be appreciated that the housing 36 of the latch assembly 24 can be shaped to perform any of these functions, and in some cases can eliminate the need for a separate support bracket 40. In this regard, the housing 36 and/or the support bracket 40 can function as a frame upon which the user-manipulatable control 52, ratchet 44, and pawl 48 is supported. As used herein and in the appended claims, the term “frame” therefore refers to the support bracket 40, the housing 36 or any combination thereof.

As will be described in greater detail below, the ratchet 44 is rotatable between an unlatched position in which a striker 94 of the striker assembly 28 is free to move into and out of the ratchet 44 and a latched position in which the ratchet 44 traps and holds the striker 94 (thereby preventing movement of the striker 94 with respect to the latch assembly 24). In the illustrated exemplary embodiment, the ratchet 44 is biased toward the unlatched position by the first biasing member 56. However, the ratchet 44 can be retained in its latched position by engagement with the pawl 48 as shown in FIG. 1. In the illustrated exemplary embodiment, the pawl 48 is biased toward engagement with the ratchet 44 by the first biasing member 56. The ratchet biasing arm 108 provides a location to which the first biasing member 56 can be connected to the ratchet 44, while the first pawl biasing arm 124 provides a location to which the first biasing member 56 can be connected to the pawl 48. It will be appreciated that other features of the ratchet 44 and pawl 48 can instead be employed to attach the first biasing member 56, such as apertures in the ratchet 44 and pawl 48, pins or posts to which the ends of the first biasing member 56 can be attached in any conventional manner, and the like. Accordingly, the ratchet 44 and pawl 48 can have other features and elements (other than arms 124, 108 as shown) for connection to one or more biasing members as described herein.

In some embodiments such as that shown in the figures, the same biasing member 56 is employed to both rotatably bias the ratchet 44 toward its unlatched position and to bias the pawl 48 toward engagement with the ratchet 44. With reference to FIG. 4 for example, the first biasing member 56 is interconnected between the ratchet biasing arm 108 and the first pawl biasing arm 124 in an extended state and, therefore, exerts a force on the ratchet biasing arm 108 and the first pawl biasing arm 124 in a direction generally toward one another. The first biasing member 56 can remain at least partially extended in both the latched and unlatched conditions of the seat latch 20. In other embodiments, dedicated biasing members can be attached to the ratchet 44 and pawl 48 (and to the latch housing 36 or other latch structure) to perform the ratchet and pawl biasing functions described above.

As discussed above, the ratchet 44 and pawl 48 each have arms 124, 108 to which one or more biasing members (e.g., spring 56) can be connected to bias the ratchet 44 toward an unlatched position and to bias the pawl 48 toward the ratchet 44. In some embodiments, the ratchet 44 and pawl 48 can be biased in these directions in other manners and using other elements, such as by torsional springs on the ratchet and pawl pivots to rotatably bias the ratchet 44 and pawl 48, springs or other elastic elements coupled to the ratchet 44 and pawl 48 and coupled to the housing 36 or support bracket 40, and the like. In those embodiments in which arms 124, 108 are employed to connect one or more biasing elements to the ratchet 44 and pawl 48, it should also be noted that these arms 124, 108 need not necessarily extend through any portion of the support bracket 40 (if used). Instead, the arms 124, 108 can extend in an opposite direction to that shown in the figures, can extend in the plane of the ratchet 44 and pawl 48, or in any other direction still permitting connection of the biasing element(s) to the ratchet 44 and pawl 48. In some embodiments, the direction in which such arms 124, 108 extend and the general manner in which biasing elements can be connected to the ratchet 44 and pawl 48 depend at least partially upon the shape of the housing 36 and support bracket 40 (if employed).

For reasons that will be discussed in greater detail below, the pawl 48 is connected to the user-manipulatable control 52 by the second biasing member 60. In the illustrated exemplary embodiment for example, the second biasing member 60 is coupled at one end to the second pawl biasing arm 128 and at another end to the user-manipulatable control 52. However, in other embodiments, the second biasing member 60 can be coupled to the pawl 48 in any other suitable manner, such as by an aperture in the pawl 48, a pin or post to which an end of the second biasing member 60 can be attached in any conventional manner, and the like. Accordingly, the pawl 48 can have other features and elements (other than the second pawl biasing arm 128) for connection to the second biasing member 60.

In some embodiments of the present invention, the user-manipulatable control 52 has a latched position corresponding to a latched state of the seat latch 20. This latched position of the user-manipulatable control 52 can have any relationship with respect to the latch assembly housing 36 (e.g., recessed within or protruding from the latch assembly housing 36, flush with surrounding portion(s) of the latch assembly housing 36, and the like. In the illustrated exemplary embodiment, the top surface of the user-manipulatable control 52 is substantially flush with the adjacent portions of the latch assembly housing 36 in the latched position of the user-manipulatable control 52. This relationship in the latched position provides an advantage in that the user-manipulatable control 52 is at least partially protected from snagging or shearing that could otherwise occur if the user-manipulatable control 52 protruded beyond the adjacent latch assembly housing 36.

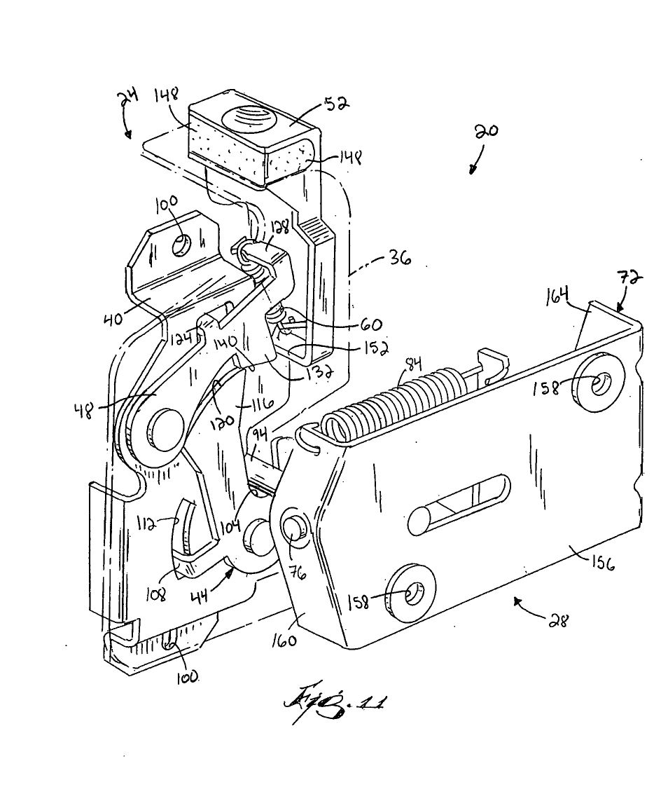

With continued reference to the illustrated exemplary embodiment, the user-manipulatable control 52 can travel along a first path in which the user-manipulatable control 52 is moved in a generally upward direction to facilitate movement of the seat latch 20 to the unlatched condition, and a second path in which the user-manipulatable control 52 is moved in a generally downward direction to facilitate movement of the seat latch 20 to different reclining positions and/or to a substantially vertical position (see FIG. 10).

The user-manipulatable control 52 can include a plurality of surfaces 148 having an enhanced visual appearance (e.g., brightly colored, reflective, and the like) that enables ready identification of the extended portion of the user-manipulatable control 52 when in the unlatched position described above. Specifically, when the user-manipulatable control 52 has been moved along the first path to its unlatched position, the surfaces 148 become exposed to operator view, thereby acting as an indicator or flag to indicate to the operator that the seat latch 20 is in an unlatched condition. The surface(s) 148 can be painted or dyed with a bright color (e.g., red, orange, white, yellow, and the like), can be defined by a portion of the user-manipulatable control 52 made of such a color, can be provided with a decal, overlay, or other element glued, taped, or otherwise bonded in any manner to the user-manipulatable control 52 and having such a color, can have a mirrored or otherwise reflective appearance (in any such manner), and the like. Any other manner of highlighting the surface(s) 148 can be employed, and falls within the spirit and scope of the present invention.

With continued reference to FIGS. 3 and 4, a portion of the user-manipulatable control 52 is movable into contact with the striker assembly 28 when the user-manipulatable control 52 is moved in the second path as described in greater detail below. Although any portion of the user-manipulatable control 52 can be employed for this purpose (depending at least partially upon the shape, position, and orientation of the user-manipulatable control 52), a flange 152 of the user-manipulatable control 52 is movable into contact with the striker assembly 28 in the illustrated exemplary embodiment.

In the illustrated embodiment, the user-manipulatable control 52 is manually actuated in the first and second paths. However, it will be appreciated that the user-manipulatable control 52 can be driven by a number of different conventional actuators positioned with respect to the user-manipulatable control 52 to exert force upon the user-manipulatable control 52 and to thereby move the user-manipulatable control 52 in the first and second paths. In such cases, the actuator(s) can be mounted within the latch assembly 20 in any suitable manner (e.g., mounted to the latch housing 36, mounted to the support bracket 40, and the like) and can be connected to or otherwise movable to exert force against the user-manipulatable control 52 in any suitable manner. By way of example only, the user-manipulatable control 52 can be actuated by one or more electrical solenoids, motor-driven cams, linkages, or other elements, and the like.

Referring to FIGS. 5 and 6, some embodiments of the striker assembly housing 72 include a back plate 156 defining connecting holes 158 for receiving fasteners (not shown) for connecting the striker assembly housing 72 to the vehicle 70, and first and second side flanges 160, 164. The side flanges 160, 164 extend substantially perpendicular from ends of the back plate 156 and the carriage slide 76 is connected at its ends to the side flanges 160, 164. In some embodiments, the striker assembly housing 72 functions to provide one or more mounting locations to mount the striker assembly 28 to the vehicle (or seat, in those embodiments in which the striker and latch assemblies 28, 24 are reversed in position from the arrangement shown in the figures) and to provide a support structure for the carriage slide 76. To this end, any other striker assembly housing structure and shape capable of performing these functions can be employed. For example, the striker assembly housing 72 can be secured to the vehicle via one or more pins, posts, or fingers extending from the striker assembly housing 72, by one or more conventional fasteners of any other type, by welding, brazing, clamping, or in any other manner desired. As another example, the carriage slide 76 can be secured to a striker assembly housing 72 having any other shape, such as by being cantilevered from a side of the striker assembly housing 72 (in which case the carriage slide 76 can have an enlarged end or other element serving as a stop for the carriage 80 at the free end of the carriage slide 76), and the like.

In the illustrated embodiment, the carriage slide 76 has a generally round cross-sectional shape. However, the carriage slide 76 can have any cross-sectional shape permitting movement of the carriage 80 therealong (as described in greater detail below), such as, for example square, rectangular, triangular, and elliptical cross-sectional shapes.

With continued reference to the illustrated exemplary embodiment, the carriage 80 is slidably supported on the carriage slide 76 and includes a pinch plate portion 168 and a striker portion 172. The pinch plate portion 168 includes pinch plates 174 slidably connected to the carriage slide 76 at a first end 176 of the pinch plates 174 via pinch plate apertures 180 (see FIG. 5) defined through the pinch plates 174. The pinch plates 174 are each biased toward one another at a second end 184 by a pinch plate biasing member 186. By biasing the pinch plates 174 together at the second end 184, the pinch plates 174 bind against the carriage slide 76, thereby preventing the carriage 80 from freely sliding along the carriage slide 76.

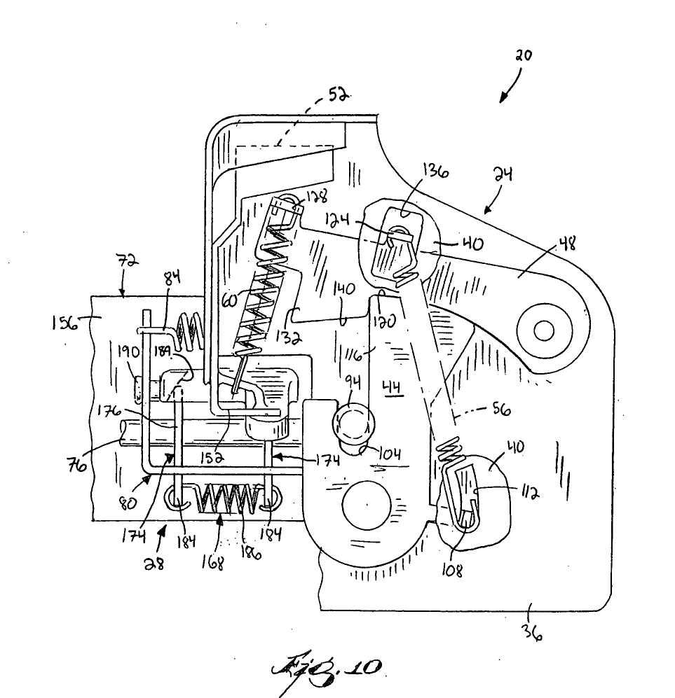

The illustrated exemplary pinch plate portion 168 also includes a pinch plate lever 188 interconnected with the pinch plates 174. The pinch plate lever 188 is rotatable with respect to the pinch plates 174 in order to bias the pinch plates 174 apart (thereby releasing the pinch plates 174). The pinch plate lever 188 can be rotatably mounted in any suitable manner, such as about a carriage shaft 190 as shown in the figures, by any other pin or pivot secured with respect to the striker assembly housing 72, and the like. With continued reference to the illustrated exemplary embodiment, actuating the pinch plate lever 188 in a downward direction biases the first ends 176 of the pinch plates 174 toward one another to overcome the biasing of the biasing member 186 and to release the pinch plates 174 from the carriage slide 76. As best shown in FIGS. 9 and 10, the pinch plate lever 188 has cam surfaces 189 (shown in phantom in FIGS. 9 and 10) that cam against the first ends 176 of the pinch plates 174 as the pinch plate lever 188 is rotated as just described, thereby generating the force to bias the first ends 176 of the pinch plates 174 toward one another.

The pinch plate lever 188 can be biased in a number of different manners away from a state in which the pinch plate lever 188 releases the pinch plates 174. Any springs, elastic elements, magnets, or other elements can be coupled to the pinch plate lever 188 for this purpose. By way of example only, the pinch plate lever 188 illustrated in the figures is biased in an upward direction by a carriage spring 192 supported on the carriage shaft 190 and engaged with the pinch plate lever 188.

The striker portion 172 of the carriage 80 includes a striker 94 that is inter-connectable with the latch assembly 24. In the illustrated embodiment, the striker 94 is a cantilevered pin or post. However, the striker 94 can have any other shape, such as, for example, a U or L-shaped striker, a striker having any other cross-sectional shape (e.g., square, rectangular, triangular, and elliptical), and the like.

In some embodiments, the carriage 80 of the striker assembly 28 is biased in a direction to bias at least a portion of the seat (e.g., the seat back 68) to a desired state, such as to a forward position and/or vertical orientation. The carriage 80 can be biased in this manner by a number of different biasing elements, including without limitation one or more springs, elastic elements, magnets, and the like. In the illustrated exemplary embodiment for example, a carriage biasing member 84 in the form of a spring is interconnected with the carriage 80 and the striker assembly housing 72 to bias the carriage 80 toward the first side flange 160. In other embodiments, the carriage 80 can be biased in an opposite direction with a carriage biasing member 84. In still other embodiments, no carriage biasing member 84 is employed to bias the carriage 80 in a particular direction.

When the carriage 80 is moved in this direction, the seat back 68 is moved to a generally upright vertical position with relation to the substantially horizontal seat base 64. When the carriage 80 is moved in an opposite direction (i.e., toward the second side flange 164), the seat back 68 is moved to a reclined position with relation to the seat base 64 (discussed in greater detail below). In some embodiments, the carriage 80 is slidable along the carriage slide 76 and is positionable in a number of different positions between the first and second side flanges 160, 164. For example, the carriage 80 illustrated in the figures can be moved through a range of positions along the carriage slide 76, and can be secured in any of these positions to provide a range of seat reclining positions.

Having described the structural components of the exemplary seat latch 20 illustrated in the figures, the operation of the seat latch 20 will now be described.

Referring first to FIG. 7, the seat latch 20 is connected to the seat 32 and the vehicle 70. With reference also to FIGS. 1 and 2, the latch assembly 24 is connected to the seat 32 and the striker assembly 28 is connected to an interior surface of the vehicle 70. It is often desirable to recline the seat back 68 or to move the seat 32 to a dump position in which the seat base 64 moves forward (such as along a track, by a sliding and/or tipping frame, and the like) and/or in which the seat back 68 is folded forward toward the seat base 64 to facilitate access to the back seat of the vehicle 70 or the space behind the seat 32.

Referring to FIGS. 9 and 10, operation of the seat latch 20 relating to the reclining function of the seat back 68 will now be discussed. In the illustrated exemplary embodiment, the seat back 68 can only be reclined while the seat latch 20 is in the latched condition. In the latched position, the striker 94 moves sufficiently into the latch aperture 88 to operatively position the pinch plate lever 188 with respect to the user-manipulatable control 52. In this position, depression of the user-manipulatable control 52 (described in greater detail below) causes actuation of the pinch plate lever 188, thereby releasing the carriage 80 to move with respect to the carriage slide 76. When the striker 94 has not moved sufficiently into the latch aperture 88 (e.g., in the latched state of the seat latch illustrated in FIG. 9), depression of the user-manipulatable control 52 does not actuate the pinch plate lever 188. However, in some embodiments of the present invention, the seat back 68 can be reclined when the seat latch 20 is not in the latched condition. For example, the shape and/or size of the flange 152 and the pinch plate lever 188 can be changed to permit actuation of the pinch plate lever 188 in other positions of the latch assembly 24 with respect to the striker assembly 28 (e.g., by widening the pinch plate lever 188, enlargening the flange 152 of the user-manipulatable control 52 that contacts the pinch plate 188, and the like), rather than in just the latched positions of these assemblies.

To recline the seat back 68 using the illustrated seat latch 20, the user-manipulatable control 52 is depressed or biased along the second path (which extends the second biasing member 60 to apply downward biasing force to the pawl 48). Due to the engagement between the pawl 48 and the ratchet cam arm 116 in the latched condition, the pawl 48 cannot rotate downward under the biasing force of the second biasing member 60. Therefore, the seat latch 20 cannot move from the latched condition to the unlatched condition. When depressed, the flange 152 of the user-manipulatable control 52 engages the pinch plate lever 188 to force the pinch plate lever 188 in a downward direction. The downward force upon the pinch plate lever 188 biases the first ends 176 of the pinch plates 174 toward one another to release the pinch plates 174 from the carriage slide and to thereby facilitate movement of the carriage 80 along the carriage slide 76.

In some embodiments, an the electrical actuator (not shown) can be positioned to actuate the pinch plate lever 188 in order to release the carriage 80. By way of example only, such an actuator can be mounted to the latch assembly housing 36 to press against the pinch plate lever 188, or can be mounted on the striker assembly 28 to press against the pinch plate lever 188 or to otherwise rotate the pinch plate lever 188 in any manner. In other embodiments, the electrical actuator can be mounted to engage the pinch plates 174 to move the first ends 176 of the pinch plates 174 toward one another for releasing the carriage 80. Still other manners of releasing the carriage 80 using one or more solenoids, motors, and other actuators are possible and fall within the spirit and scope of the present invention.

After the carriage 80 has been released to move with respect to the rest of the striker assembly 28, the occupant of the seat 32 can recline the seat back 68, such as by pressing against the seat back 68. The force exerted against the seat back 68 must be sufficient to overcome the biasing force of the carriage biasing member 84 (if employed). By overcoming the biasing force of the carriage biasing member 84 in the illustrated embodiment, the carriage 80 will move away from the first side flange 160 and slide along the carriage slide 76 to recline the seat back 68 toward the rear of the vehicle 70. Also with reference to the illustrated embodiment, the seat back 68 is positioned in the most reclined position when the carriage 80 engages the second side flange 164. The second side flange 164 limits movement of the carriage 80 and therefore limits the amount that the seat back 68 can be reclined. In other embodiments, movement of the carriage 80 and reclining of the seat back 68 can be limited in other manners, such as one or more protrusions on the carriage slide 76 limiting travel of the carriage 80, a striker assembly housing 72 (and carriage slide 76) that is longer or shorter that that shown in the figures, one or more protrusions on the striker assembly housing 72 performing a similar function, one or more protrusions extending from the second side flange 164 toward the carriage 80, a portion of the carriage 80 extending toward the second side flange 164, and the like. Any element or structure positioned to limit movement of the carriage 80 (and therefore, the amount which the seat back 68 can be reclined) can be employed while still falling within the spirit and scope of the present invention.

With continued reference to the exemplary embodiment illustrated in the figures, when the seat back 68 is positioned in a desired reclining position, the occupant can release the user-manipulatable control 52. The extended second biasing member 60 exerts an upward force on the user-manipulatable control 52 to return the user-manipulatable control 52 to the position in which the top surface of the user-manipulatable control 52 is substantially flush with the latch assembly housing 36. The carriage spring 192 biases the pinch plate lever 188 upward to release the inward bias on the first ends 176 of the pinch plates 174, thereby causing the second ends 184 of the pinch plates 174 to be biased toward one another under the biasing of the pinch plate biasing member 186. The pinch plates 174 once again engage the carriage slide 76 to an extent that prevents the carriage 80 from sliding along the carriage slide 76, thereby securing the carriage 80 and seat back 68 in a new position (e.g., a new reclined position).

The seat back 68 in the illustrated embodiment can be un-reclined or rotated toward the front of the vehicle 70 by again biasing the user-manipulatable control 52 downward (in a similar manner to that discussed above) and by moving or permitting the seat back 68 to move in a direction toward the front of the vehicle, such as under spring force of the carriage biasing member 84. Accordingly, the carriage 80 will slide along the carriage slide 76 in a direction toward the first side flange 160 and the seat back 68 will rotate toward the front of the vehicle 70. Releasing the user-manipulatable control 52 will re-secure the seat back 68 in a desired position in a similar manner to that discussed above.

As described above, in some embodiments the seat back 68 can only be reclined when the seat is in the latched condition. In the illustrated embodiment for example, this limitation is generated by the positional relationship between the user-manipulatable control 52 and the pinch plate lever 188. In this embodiment, the pinch plate lever 188 can only be actuated when movement of the user-manipulatable control 52 can actuate the pinch plate lever 188. This is possible only when the striker 94 has moved sufficiently into the latch aperture 88 to latch the pawl 48 with the ratchet 44. In these and other embodiments, the user-manipulatable control 52 can be blocked or otherwise disabled from releasing the pinch plate lever 188 (or other element releasing the latch assembly 24 from the striker assembly 28) in other manners.

In some embodiments, one or more elements of the latch assembly 24 can interfere with the ability of the user-manipulatable control 52 to actuate or fully actuate the pinch plate lever 188. For example, the user-manipulatable control 52 can directly or indirectly interfere with the ratchet 44 when the ratchet 44 is in a released or partially released position. In the illustrated embodiment, the flange 152 or other part of the user-manipulatable control 52 can be blocked by the ratchet 44 in the released position of the ratchet 44 (see FIG. 3), thereby preventing the user-manipulatable control 52 from being able to actuate or fully actuate the pinch plate lever 188. As another example, the user-manipulatable control 52 can directly or indirectly interfere with the pawl 48 when the pawl 48 is in a released or partially released position. In the illustrated embodiment, the angled side wall of the user-manipulatable control 52 can be blocked by the second pawl biasing arm 128 in the released position of the pawl 48 (see FIG. 3), thereby preventing the user-manipulatable control 52 from being able to actuate or fully actuate the pinch plate lever 188.

As yet another example, in those embodiments in which the latch assembly 24 is provided with a powered actuator to actuate the pinch plate lever 188 as described above, one or more sensors or switches can be positioned to detect the latched or unlatched state of the latch assembly 24. This can be performed by detecting the rotational position of the ratchet 44 and/or of the pawl 48, by detecting the position of the latch assembly 24 with respect to the striker assembly 28, or in any other suitable manner. When an unlatched or partially unlatched position is detected, the powered actuator can be disabled or otherwise will not be actuated (e.g., by an electrical controller) to actuate the pinch plate lever 188. Still other manners of blocking or otherwise disabling the user-manipulatable control 52 from releasing the striker assembly 28 are possible and fall within the spirit and scope of the present invention.

In other embodiments, the user-manipulatable control 52 can be disabled from releasing the pinch plate lever 188 (or other element releasing the latch assembly 24 from the striker assembly 28) in other still other manners.

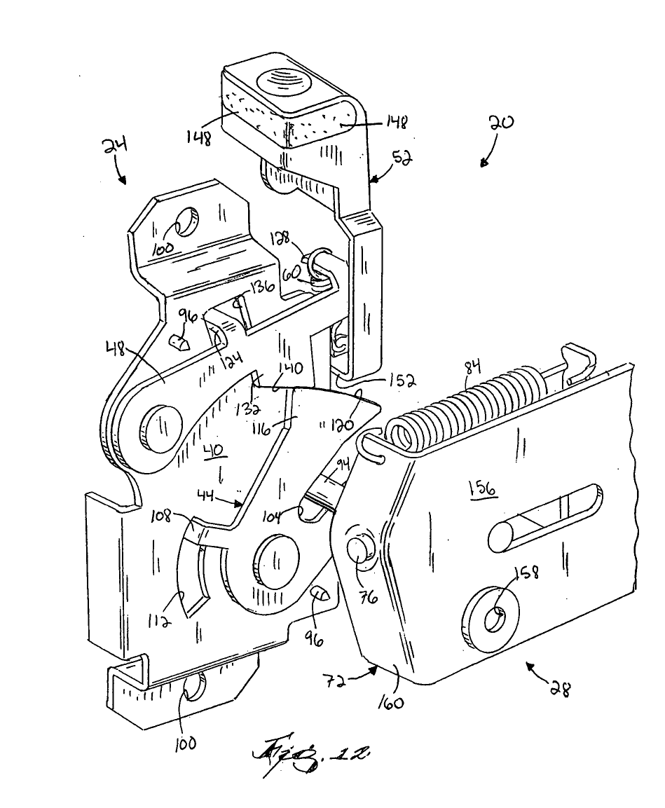

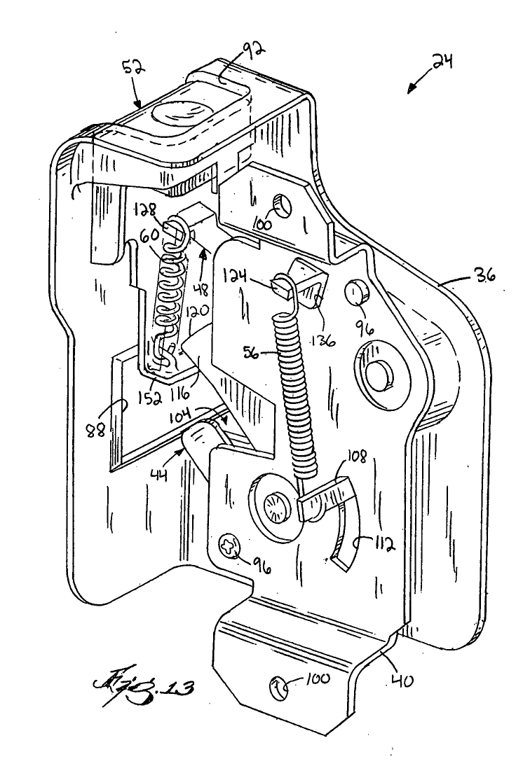

Referring to FIGS. 11 and 12, operation of the seat latch 20 as it is changed between latched and the unlatched conditions will be discussed. First, to move the seat latch 20 from a latched condition to an unlatched condition in the illustrated exemplary embodiment, the user-manipulatable control 52 is moved upward along the first path to move the seat latch 20 to a first unlatching position (see FIG. 11). Upward movement of the user-manipulatable control 52 compresses or otherwise reduces the spring force of the second biasing member 60 (unless already compressed). If fully compressed, the second biasing member 60 can be employed to transmit upward motion from the user-manipulatable control 52 to the pawl 48. In these and other embodiments, the flange 152 or other portion of the user-manipulatable control 52 can move the pawl 48 to a released position with respect to the ratchet 44. In some embodiments, the pawl cam arm 132 rises as the pawl 48 rotates upward, and eventually releases the ratchet cam arm 116 from behind the pawl cam arm 132. Upon ratchet release, the striker 94 can be moved out of the latch slot 104 by moving the seat 32 toward the front of the vehicle 70. Such motion forces the striker 94 against the ratchet 44, thereby rotating the ratchet 44, and in some embodiments brings the ratchet cam surface 120 into contact with the pawl cam surface 140. After movement of the seat latch 20 to a second unlatching position (see FIG. 12), the ratchet 44 is sufficiently rotated to facilitate movement of the striker 94 out of the latch slot 104 and the latch aperture 88 (see FIGS. 1-3). In this second unlatching position, the seat latch 20 is in an unlatched condition.

With continued reference to the illustrated exemplary embodiment, due to the engagement between the pawl 48 and the ratchet 44 in the unlatched condition, the second biasing member 60 is biased upward to exert an upward force on the user-manipulatable control 52, thereby holding the user-manipulatable control 52 in an upward position. In the upward position, the side surfaces 148 of the user-manipulatable control 52 containing the bright colors and/or other indicia are visible to indicate that the seat latch 20 is in the unlatched condition. Although the second biasing member 60 can be employed to retain the user-manipulatable control 52 in the upward position, the user-manipulatable control 52 can be retained in this position in a number of other manners, such as by an over-center spring connected to the user-manipulatable control 52 and to the housing 36, one or more resilient protrusions or recesses on the user manipulatable-control 52 releasably engagable with one or more recesses or protrusions on the housing 36, respectively, to provide an amount of resistance against moving the user-manipulatable control 52 out of the upward position, and the like.

With reference back to the illustrated exemplary embodiment, the user-manipulatable control 52 is biased toward the upward position until the seat latch 20 is moved to the latched condition. The user-manipulatable control 52 acts as a flag or other indicator, and is convenient because the occupant or other party is informed that the seat latch 20 is not in the latched condition (which could be a condition that is unsuitable for seat occupancy during vehicle operation).

Referring to FIG. 13, the seat latch 20 of illustrated exemplary embodiment is in a third unlatching position in which the user-manipulatable control 52 is depressed while the seat latch 20 is in the unlatched condition. The user-manipulatable control 52 will not remain in the downward position after it has been depressed, but will instead return to the upward position shown in FIG. 11, in which the sides 148 of the user-manipulatable control 52 are visible above the latch assembly housing 36. When the latch 20 is in the unlatched condition and the user-manipulatable control 52 is depressed (e.g., intentionally or inadvertently by a user), the second biasing member 60 is extended and tensioned to provide a downward bias on the pawl 48 and an upward bias on the user-manipulatable control 52. Since the pawl cam arm 132 engages the ratchet cam arm 116 in the illustrated embodiment, the pawl 48 cannot rotate downward to release tension from the second biasing member 60. Therefore, the tension of the second biasing member 60 is released by returning the user-manipulatable control 52 to its upward position. This feature can therefore enable the user-manipulatable control 52 to be depressed in different states of the seat latch 20 (e.g., latched, partially unlatched, unlatched, reclined to any degree, unreclined, etc.) without damage to the user-manipulatable control 52, such as from being stepped on, impacted, and the like.

Referring back to FIGS. 11 and 12, the seat latch 20 is moveable from an unlatched condition to a latched condition (e.g., by movement of the seat from a dump position to a position in which an occupant can sit in the seat) by moving the seat 32 backwards toward the striker assembly 28. In some embodiments, the occupant manually pushes or otherwise rotates the seat back 68 away from the seat base 64 and/or biases the seat base 64 backwards toward the striker assembly 28. The striker 94 is thereby inserted into the latch slot 104 and engages the ratchet 44 to rotate the ratchet 44. As the ratchet 44 begins to rotate in the illustrated embodiment, the ratchet cam surface 120 cams against the pawl cam surface 140. Depending at least partially upon the shapes and relative positions of the ratchet 44 and pawl 48, the ratchet biasing arm 108 can pull on the first biasing member 56 to create increased tension in the first biasing member 56. The ratchet 44 continues to rotate until the ratchet cam arm 116 moves behind the pawl cam arm 132, at which point the biasing force from the first biasing member 56 biases the pawl 48 downward to capture the ratchet cam arm 116 behind the pawl cam arm 132. This downward movement of the pawl 48 moves the second biasing member 60 downward against the user-manipulatable control 52 (or in other embodiments, moves the pawl 48 or other element attached to the pawl 48 against the user-manipulatable control 52) to move the user-manipulatable control 52 downward to the position in which the side surfaces 148 are no longer visible or have reduced visibility. For example, the user-manipulatable control 52 in the illustrated embodiment is moved to a position in which the top surface of the user-manipulatable control 52 is substantially flush with the latch assembly housing 36. The striker 94 is thereby secured within the latch slot 104 and the seat latch 20 is in the latched condition.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

For example, some embodiments of the present invention do not employ a striker assembly 28 as described above and illustrated in the figures. Any adjustable or non-adjustable striker 94 can be releasably engaged with the latch assembly 24, such as a striker 94 secured against movement with respect to the vehicle 70, or a striker having a position adjustable in any manner. It will be appreciated that a non-movable striker used in conjunction with the latch assembly 24 of the present invention can limit the latch features described herein, such as the ability of an operator to recline the seat 32 of the vehicle 70.

As another example, the user-manipulatable control 52 in the illustrated exemplary embodiment is in the form of a button having a top portion that can be depressed and lifted by a user and a bottom portion that extends within the latch assembly 24 to operate upon the pawl 48 and the striker assembly 28. It will be appreciated that the button-type user-manipulatable control 52 can be replaced by a number of other elements that perform the same or similar functions. By way of example only, the user-manipulatable control 52 can be a lever or switch pivoted at a point on the housing 36 or support bracket 40, having a first end that can be pushed and pulled by a user, and having a second end that actuates the pawl 48 and striker assembly 28 in a manner similar to the user-manipulatable control 52 described above. In other embodiments, the user-manipulatable control 52 can be a dial that can be turned by a user and that has an interior lever or connection location through which force can be transmitted to the pawl 48 and striker assembly 28 by turning the dial. Still other types of user-manipulatable controls can be employed as desired. In each embodiment, the user-manipulatable control can have one or more indicators (e.g., colored portions, symbols, and the like) to provide a visual indication regarding the state of the latch assembly 24 in one or more positions of the user-manipulatable control 52.

The seat latch 20 illustrated in the figures is operable to unlatch a seat or seat portion when the user-manipulatable control 52 is lifted, and to permit the seat to be reclined when the user-manipulatable control 52 is depressed. These functions can be performed by a user-manipulatable control 52 operable in other manners, such as by a user-manipulatable control 52 that can be depressed to unlatch the seat or seat portion and that can be lifted to permit the seat to be reclined. In this alternative arrangement, the general arrangement of the striker assembly 28, ratchet 44, and pawl 48 can be inverted with respect to the user-manipulatable control 52 illustrated in the figures, in which case lifting the user-manipulatable control 52 would cause the flange 152 to lift the pinch plate lever 188 and release the pinch plates 174, while depressing the user-manipulatable control 52 would cause the pawl 48 connected thereto to be pushed and released from the ratchet 44. In other embodiments employing other types of user-manipulatable controls as described above, the user-manipulatable control 52, pawl 48, ratchet 44 and striker assembly 28 can be re-arranged in a number of other manners while still resulting in a structure in which actuation of the user-manipulatable control in a first direction or manner actuates the striker assembly 28 and in which actuation of the user-manipulatable control in a second direction or manner unlatches the seat latch 20.

The seat latch 20 of the present invention can employ one or more biasing members 56, 60, 84, 186 to bias various elements into or toward positions as described herein. In the illustrated exemplary embodiment, each of these members is a coil spring. However, it will be appreciated that a number of other biasing elements and structures can instead be employed to perform the same functions as the coil springs. By way of example only, any one or more of the biasing members 56, 60, 84, 186 can be replaced with elastic bands, ties, or other elements, springs of different types (e.g., torsion, leaf, and other spring types), magnet or electromagnet sets, and the like.

1. A seat latch for controlling operation of a vehicle seat within a vehicle, the vehicle seat having a seat base and a selectively positionable seat back pivotally coupled to the seat base, the seat latch comprising:
a frame connectable to one of the vehicle seat and the vehicle; and
a user-manipulatable control supported by the frame, the user-manipulatable control operable to facilitate movement of the seat latch between a latched condition in which at least part of the vehicle seat is secured against movement with respect to the vehicle and an unlatched condition in which the at least part of the vehicle seat is movable with respect to the vehicle;
the user-manipulatable control also operable to facilitate movement of the seat back between a plurality of reclined positions;
the user-manipulatable control retained in at least one position when the seat is in the unlatched condition and in which the user-manipulatable control provides a visual indication that the seat latch is not in the latched condition.

2. The seat latch as claimed in claim 1, wherein the user-manipulatable control is movable along a first path to release the seat latch from the latched condition to the unlatched condition, and along a second path enabling the seat back to be reclined but not releasing the seat latch from the latched condition to the unlatched condition.

3. The seat latch as claimed in claim 1, further comprising a ratchet coupled to the user-manipulatable control and selectively engagable with a striker, the striker connectable to the other of the vehicle seat and the vehicle.

4. The seat latch as claimed in claim 3, wherein:
the ratchet is releasably engaged with the striker in the latched condition to prevent substantial movement of the ratchet relative to the striker; and
the ratchet is disengagable from the striker in the unlatched condition to facilitate movement of the striker relative to the ratchet.

5. The seat latch as claimed in claim 1, further comprising a biasing member coupled to the user-manipulatable control, the user-manipulatable control movable between a first position and a second position, the user-manipulatable control movable toward the second position to place the seat latch in the unlatched condition, the user-manipulatable control biased toward the second position when the seat latch is in the unlatched condition.

6. The seat latch as claimed in claim 1, wherein the user-manipulatable control is movable from a first position to a second position to place the seat latch in the unlatched condition, the user-manipulatable control biased toward the second position when the seat latch is in the unlatched condition, the user-manipulatable control movable from the first position to a third position permitting the seat back to be reclined to different positions but not generating release of the seat latch from the latched condition, the user-manipulatable control biased toward the first position when moved toward the third position.

7. The seat latch as claimed in claim 1, wherein the user-manipulatable control has at least one surface substantially hidden from view when the seat latch is in the latched condition and providing a visible indicator when the seat latch is in the unlatched condition.

8. The seat latch as claimed in claim 7, wherein the user-manipulatable control includes a brightly colored surface visible only when the seat latch is in the unlatched condition.

9. A seat latch having a reclining condition, a latched condition and an unlatched condition, the seat latch comprising:
a housing;
a user-manipulatable control received at least partially within the housing, movable along a first path to move the seat latch from the latched condition to the unlatched condition, and movable along a second path to move the seat latch into and out of the reclining condition but retaining the seat latch in the latched condition, the user-manipulatable control protruding outside of the housing when the latch is in the unlatched condition and not protruding beyond the housing when the latch is in the latched condition.

10. The seat latch as claimed in claim 9, wherein the user-manipulatable control includes at least one surface visible when the user-manipulatable control protrudes from the housing and recessed within the housing when the user-manipulatable control does not protrude from the housing.

11. The seat latch as claimed in claim 10, wherein the at least one surface is brightly colored to provide a visual indicator that the seat latch is in the unlatched condition.

12. The actuation device as claimed in claim 9, wherein the user-manipulatable control is biased into a position protruding from the housing when the latch is in the unlatched condition and is not biased into the position protruding from the housing when the latch is in the latched condition.

13. A seat latch for a vehicle seat within a vehicle, the seat latch comprising:
a frame connectable to one of the vehicle seat and the vehicle;
a striker connectable to the other of the vehicle seat and the vehicle;
a ratchet coupled to the frame and selectively engagable with the striker to selectively secure the frame to the striker;
a user-manipulatable control coupled to the ratchet and movable from a first position to a second position to facilitate reclining of the vehicle seat, and from the first position to a third position to facilitate disengagement of the frame from the striker; and
a biasing member coupled to the user-manipulatable control and biasing the user-manipulatable control toward the first position when the user-manipulatable control is in the second position, the biasing member not biasing the user-manipulatable control toward the first position when the user-manipulatable control is in the third position.

14. The seat latch as claimed in claim 13, wherein:
the frame includes a housing within which the user-manipulatable control is at least partially received; and
the user-manipulatable control protrudes from the housing when the user-manipulatable control is in the third position.

15. The seat latch as claimed in claim 14, wherein the user-manipulatable control does not protrude from the housing when the user-manipulatable control is in the first position.

16. The seat latch as claimed in claim 13, further comprising a pawl releasably engaged with the ratchet to retain the ratchet in a latched position capturing the striker, the biasing member coupled between the pawl and the user-manipulatable control.

17. The seat latch as claimed in claim 16, wherein movement of the user-manipulatable control from the first position to the third position rotates the pawl and releases the ratchet to an unlatched position to allow disengagement between the striker and the ratchet, the ratchet preventing rotation of the pawl and maintaining the user-manipulatable control in the third position when the ratchet is in the unlatched position.

18. The seat latch as claimed in claim 16, wherein movement of the user-manipulatable control from the third position to the first position after disengagement of the striker and the ratchet extends the biasing member to bias the user-manipulatable control toward the third position.

19. The seat latch as claimed in claim 18, wherein re-engagement of the striker and the ratchet rotates the ratchet to facilitate rotation of the pawl and movement of the user-manipulatable control from the third position toward the first position.

20. A method of moving a seat within a vehicle, comprising:
actuating a user-manipulatable control in a first manner to release a latch from a striker and to enable movement of the vehicle seat with respect to the vehicle, the latch providing a visual indicator to a user that the latch is in an unlatched condition when the latch is released from the striker;
capturing the striker with the latch; and
actuating the user-manipulatable control in a second manner different from the first manner to recline the seat.

21. The method as claimed in claim 20, wherein:
the first manner of actuating the user-manipulatable control is one of pushing and pulling the user-manipulatable control; and
the second manner of actuating the user-manipulatable control is another of pushing and pulling the user-manipulatable control.

22. The method as claimed in claim 20, wherein:
the first manner of actuating the user-manipulatable control is one of depressing and lifting the user-manipulatable control; and
the second manner of actuating the user-manipulatable control is another of depressing and lifting the user-manipulatable control.
